(19) United States
(12) Patent Application Publication
(10) Pub. No.: US 2017/0344113 A1
(43) Pub. Date: Nov. 30, 2017

(54) HAND-HELD CONTROLLER FOR A COMPUTER, A CONTROL SYSTEM FOR A COMPUTER AND A COMPUTER SYSTEM

(71) Applicant: Kurv Music Ltd., London (GB)

(72) Inventors: Michael Grierson, London (GB); Christopher Kiefer, London (GB); Suran Goon-Atilake, London (GB); Tania Fauvel, London (GB); Alexander Fauvel, London (GB); John Kennedy, London (GB)

(21) Appl. No.: 15/544,417

(22) PCT Filed: Jan. 19, 2015
(86) PCT No.: PCT/GB2015/050106

§ 371 Date: Jul. 18, 2017

(51) Int. Cl. G06F 3/01; G06F 3/0346; G06F 3/16; G10H 1/32; G10H 1/00; G06F 3/0354; G06F 3/041

(52) U.S. Cl. CPC G06F 3/014; G10H 1/0008; G06F 3/0346; G06F 3/03547; G06F 3/165; G06F 3/017; G10H 1/32; G06F 3/041; G06F 2203/04105; G10H 2220/191; G10H 2220/201; G10H 2220/326; G10H 2240/211

(57) ABSTRACT

A hand-held controller (100) for a computer is disclosed. The controller is substantially U-shaped and has front and IN rear sections (110, 130) spaced apart by a link section (140). The controller fits onto the user's hand in use so that the rear section (130) lies over the back of the hand and the front section (110) lies in the palm of the hand. The front section includes a user interface, such as a keypad, touchpad or touch area (120), to receive inputs from the user's fingers. The controller may also include a gyroscope and an accelerometer to determine the orientation and movement of the controller. The controller further comprises a transmitter for transmitting data relating to the user inputs to the computer, the data causing the computer system to carry out one or more pre-assigned actions. The pre-assigned action may comprise playing or altering an audio sound, or changing the key, pitch, tone, sound quality or volume of the audio sound. A control system for a computer comprising two hand-held controllers is also disclosed. The hand-held controllers may be the same, or one may be configured to receive only orientation and movement user inputs. A computer system comprising two hand-held controllers and a computer is also disclosed. In preferred embodiments, the computer system is a musical instrument emulator.

The present invention relates to a hand-held controller for a computer, a control system for a computer comprising two hand-held controllers, and to a computer system comprising two hand-held controllers and a computer.

### BACKGROUND

Established methods for controlling computer systems include keyboards, mice and touchscreens. They have disadvantages in that they require the user to be in position facing the computer, for example at a desk using a keyboard and mouse.

Portable touchscreen devices can partially solve these issues. People can at least move whilst holding the screen and use it as an input device, but these devices still require the person to use the screen in order to control the computer, even if the computer is mobile, as the primary control interface is on the screen.

Furthermore, established methods for controlling a computer do not allow a person to communicate expressive information to the computer system. Although existing wearable computers and smartphones use gyroscopes, accelerometers and heart sensors, they lack the high-resolution control required for complex interactions such as email and document authoring.

In addition, established methods for controlling a computer lack the expressive capacity of other types of devices that people use to communicate emotions, such as musical instruments. Established methods for controlling computers can be used to make music, but are not able to communicate a note and how the note should be played, for example.

The present invention sets out to improve established methods for controlling a computer system. In the context of the present application, “computer system” should be construed broadly and can refer to any device capable of operating in the manner described below in order to carry out the invention, including a PC, laptop, tablet, mobile device, or gaming console.

### SUMMARY OF THE INVENTION

In accordance with a first aspect, the invention provides a hand-held controller for a computer, the controller having a front section and a rear section and being configured to fit onto the user's hand in use so that the rear section lies over the back of the hand and the front section lies in the palm of the hand, wherein the controller is adapted to receive a plurality of user inputs and wherein the front section includes a user interface to receive inputs from the user's fingers, the controller further comprising a transmitter for transmitting data relating to the user inputs to the computer.

Preferably, the controller is substantially U-shaped and the front and rear sections are spaced apart by a link section.

In preferred embodiments, the user inputs are converted into data signals by a plurality of sensors. The controller preferably further comprises a processor which receives and processes the data signals for transmission to the computer.

The user interface may be a keypad, touchpad or touch area. The user interface may sense one, some or all of the following: the presence of a user's finger, the location of a user's finger and the pressure applied by a user's finger. The user interface preferably comprises a touch pad or touch area comprising an array of pressure sensors.

In preferred embodiments, the controller is adapted to receive further user inputs relating to the orientation or movement of the controller. The controller may include a gyroscope and/or an accelerometer to determine the orientation and movement of the controller.

Preferably, the front and rear sections of the controller are configured so as to maintain the controller in position on the user's hand without the need for the user to hold or otherwise grip the controller. In a preferred embodiment, this is achieved by configuring the front and rear sections to be closer together at the open end of the U-shape in order to hold the controller in position on the user's hand. Preferably, the front and rear sections can be urged apart from their rest positions against a resilient biasing force.

In accordance with a second aspect, the invention provides a control system for a computer, the control system comprising a first hand-held controller being the hand-held controller discussed above and a second hand-held controller, wherein the second controller is adapted to receive user inputs relating to the orientation or movement of the second controller and further comprises a transmitter for transmitting data relating to the user inputs to the computer.

The second controller preferably includes an accelerometer and a gyroscope to determine the orientation and movement of the second controller. In a preferred embodiment, the second controller is the hand-held controller discussed above.

In accordance with a third aspect, the invention provides a computer system comprising a first hand-held controller being the hand-held controller discussed above, a second hand-held controller and a computer, wherein the second controller is adapted to receive user inputs relating to the orientation or movement of the second controller and comprises a transmitter for transmitting data relating to the user inputs to the computer, wherein the computer receives the transmitted data relating to the user inputs from the first and second controllers and carries out pre-assigned actions in dependence on that data.

In preferred embodiments of all aspects of the invention, the data transmitted to the computer system causes the computer system to carry out one or more pre-assigned actions. Preferably, the computer recognises or learns gestures made by the user which are sensed by the first and/or second hand-controller, and wherein the computer carries out a pre-assigned action for each recognised gesture. The pre-assigned action may comprise playing or altering an audio sound, or changing the key, pitch, tone, sound quality or volume of the audio sound.

In preferred embodiments of all aspects of the invention, the computer system is a musical instrument emulator.

In at least its preferred embodiments, the present invention provides a multi-parametric wireless, palm mounted, low-profile wearable interface for the remote control of a computer or mobile device through a group of sensors. The control system has two main components that can be used individually or together. The first component clips onto the hand. It can manipulated by the wearer through simultaneous use of body motion, orientation, pressure and finger position or grasp. The second component is a device which can be manipulated by the wearer via motion and orientation. The second component may be similar to the first component, or could be a less-complex controller with fewer inputs. When employing two controllers simultaneously, the invention provides a “bi-manual” controller for a computer.

The controller of the present invention preferably generates and transmits both single and multichannel discrete and continuous control signals from a user's hands to a remote computer or mobile device for general real-time human computer interaction tasks. It can also receive single or multi-channel signals from a remote computer system.

The interface is designed so that it can be used to control any digital device, through a plurality of touch pads, contact areas or buttons that can be used simultaneously, combined with a continuous multi-channel pressure and sensor system that communicates signals from a person's motion and grasp directly to a computer system or mobile device.

The controller of the present invention has been designed so that the wearer does not need to look at it in order to use it or to grip it in the hand. The non-specialist wearer is free to move around and use the device to send complex, conscious commands without needing to see the interface. It can replace an existing mouse and keyboard combination through the application of machine learning-based gesture recognition and/or interactive predictive text software. The controller may be configured to provide haptic feedback to the wearer to provide additional, non-visual feedback to the user e.g. when a particular function has been executed successfully.

The present invention can feature as a musical controller to permit the digital emulation of an expressive musical instrument, such as a guitar.

### BRIEF DESCRIPTION OF THE DRAWINGS

The present invention will now be described by way of example only and with reference to the accompanying drawings, in which:

FIG. 1 shows a first embodiment of a first hand-held controller in accordance with the invention, in position on a user's hand with the palm-side visible;

FIG. 2 shows a second embodiment of a first hand-held controller in accordance with the invention, in position on a user's hand with the palm-side visible;

FIG. 3 shows the rear clip section of the hand-held controller of either embodiment with the back of the user's hand visible;

FIG. 4 shows the side of the hand-held controller of either embodiment;

FIGS. 5A and 5B show side views of the hand-held controller of either embodiment when not being worn on a user's hand;

FIG. 6 shows a second hand-held controller for use in conjunction with the first hand-held controller;

FIG. 7 shows a circuit block diagram of the control system of the present invention including the first hand-held controller; and

FIG. 8 shows a circuit block diagram of the control system of the present invention including the second hand-held controller.

### DETAILED DESCRIPTION OF THE INVENTION

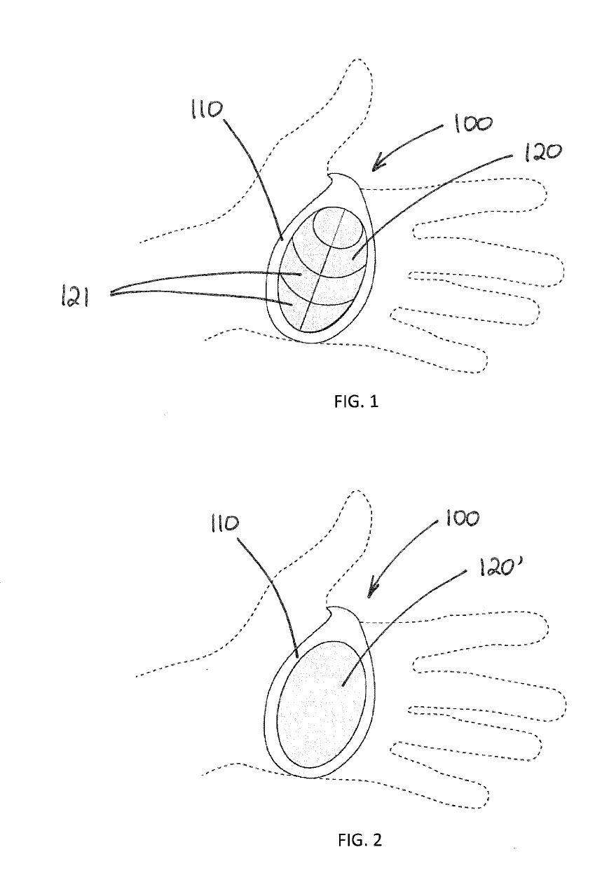

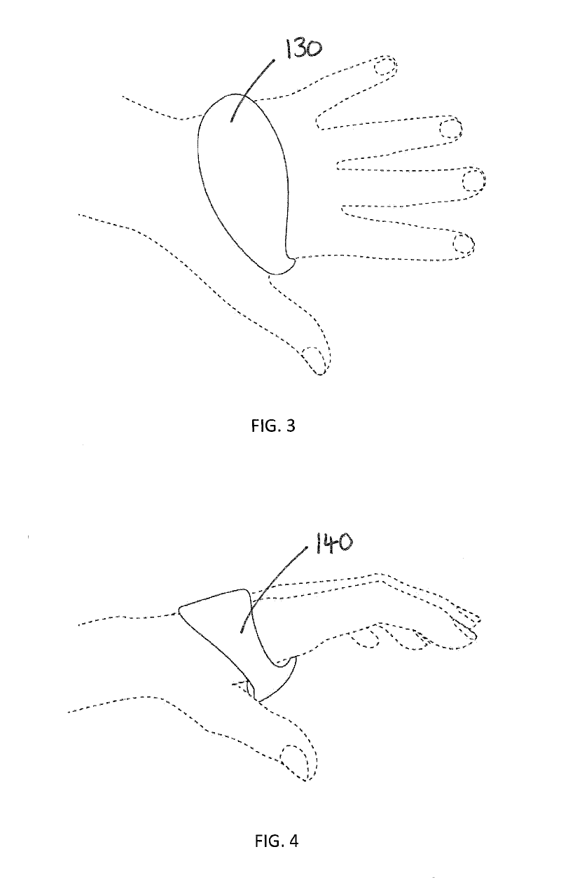

FIGS. 1 and 2 show embodiments of a first hand-held controller 100 in accordance with the invention, in position on a user's hand with the palm-side visible. The overall shape of front section 110 of both embodiments is the same. However, the first controller of the first embodiment (FIG. 1) is provided with a touch-pad 120 having two rows of four discrete contact areas 121, whereas the first controller of the second embodiment (FIG. 2) is provided with a unitary touch area 120′. Touch-pad 120 may be provided in the form of a keypad having discrete buttons as an alternative. The buttons may be arranged in two rows of four, in a similar configuration to the contact areas of touch-pad 120. In alternative embodiments, the contact areas or buttons may be arranged in a single row or more than two rows (for example, 3 or 4 rows). Any appropriate number of contact areas or buttons may be provided in each row, for example 2, 4, 6 or 8 per row.

Controller 100 sits in the palm of the user's hand and is designed so that the user's fingers can contact touch-pad 120 or touch area 120′, in a similar manner to touching the strings on a guitar fretboard.

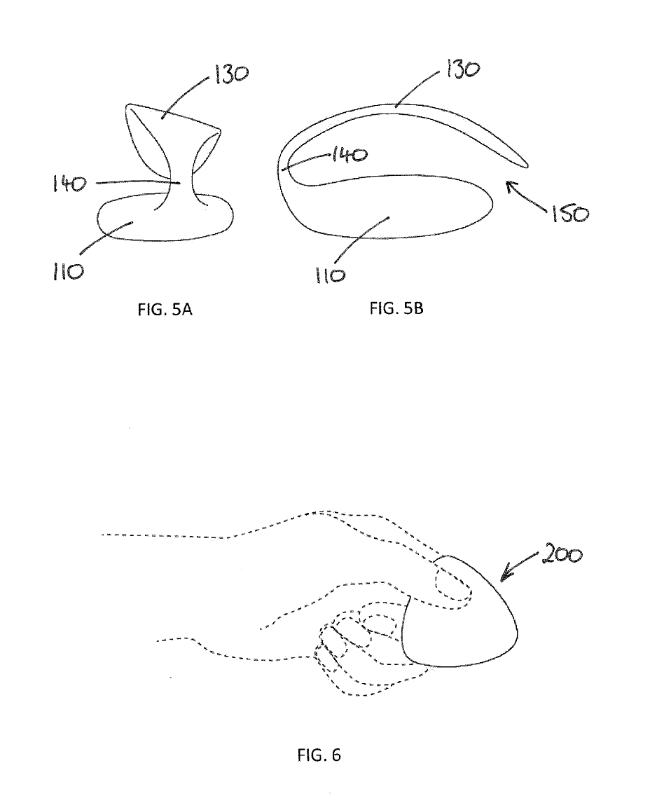

FIG. 3 shows the rear clip section 130 of the first controller 100 and FIG. 4 shows the controller from the side, with link section 140 clearly visible. As can be seen from FIGS. 5A and 5B, which show the controller when not being worn, rear clip section 130 is curved and the gap between the rear section 130 and front section 110 narrows towards or at the open end 150 of the controller 100, in order that sufficient pressure is applied to the user's hand to keep the controller in approximate position. Rear clip section 130 is resiliently sprung so that first controller 100 slips over the user's hand and clips into place.

FIG. 6 shows a second hand-held controller 200 for use in combination with the first hand-held controller 100. As mentioned above, the second controller may be the same as or similar to the first controller 100, which is described in more detail below. However, in this preferred embodiment, the second controller has a similar shape to a guitar plectrum or pick, and is intended to be used in a similar manner. The surfaces are designed to be gripped by the thumb and fingers.

Both hand-held controllers 100, 200 have a housing which may be made from any suitable material, but typically a plastics material. Each housing contains the electronics, as discussed further below. The properties of the material for the first hand-held controller will be chosen in order that the overall design of the controller exhibits the resilience discussed above when the device is placed on the user's hand.

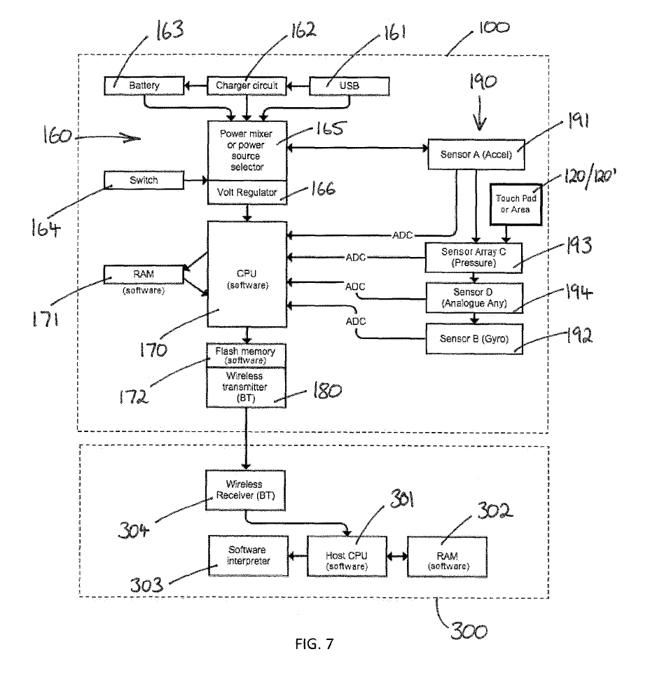

FIG. 7 shows a circuit block diagram of the control system of the present invention. The components of the first hand-held controller 100 are shown within dashed box 100 and the relevant components of the computer system 300 are shown within dashed box 300.

First controller 100 includes power supply circuitry shown generally as 160, including USB port 161, charging circuit 162, battery 163, switch 164, power mixer or power source selector 165 and voltage regulator 166. Other input/output ports may be provided in addition to USB port 161, including for example a data communications port for loading device firmware. Battery 163 is preferably rechargeable, ideally via the USB port, but it may be rechargeable by other means or may alternatively non-rechargeable. The power circuit 160 provides power to the rest of the components in a standard manner.

First controller 100 also includes a CPU 170, which has access to RAM 171 and flash memory 172. Control data for the computer system 300 is output from CPU 170 to flash memory 172 and transmitted via Bluetooth wireless transmitter 180. CPU 170 needs to be capable of running the controller's software system at a high enough speed to allow for low latency continuous transmission. CPU 170 also has a permanent memory (not shown), which needs to be large enough to hold a suitable operating system and control software.

Transmitter 180 is capable of low-latency continuous transmission (<35 milliseconds transmission time), such as a Bluetooth 4 BLE device, or any other type of communications device suitable for low-latency control. A cable can be used as an alternative.

The first controller has an array of at least 16 analogue or digital channels suitable for multichannel input and output to/from the CPU, for example 16 digital inputs/outputs, or 8 analogue inputs and 8 digital inputs/outputs.

An array of sensors 190 is provided within first controller 100 in order that the user's overall movements of the controller and specific inputs via touch pad 120 or touch area 120′ can be converted into signals, processed as necessary by the CPU and transmitted to the computer system 300. Analogue to digital converters (ADCs) are employed to convert any analogue signals from the sensors as needed.

Sensor A (191) is an accelerometer, which is preferably a six-axis accelerometer. Sensor B (192) is a gyroscope. The combination of these two sensors allows the controller's movement and orientation to be tracked. Sensor C (193) represents schematically the output from touch pad 120 or touch area 120′, discussed further below. Sensor D (194) represents any other applicable sensor which may be required for the specific application, including for example a magnetometer (used for detecting a compass bearing) or a biometric sensor such as a fingerprint sensor.

There is likely to be a plurality of outputs from touch pad 120, touch area 120′ or keypad, representing a potentially wide range of inputs or sensed parameters. Parameters may include one or more of the following: contact (i.e. present or absent), contact location, contact pressure. The combination of such parameters provide a greater degree of expression to the input device than a simple on/off or present/absent parameter.

In a preferred embodiment employing the touch pad or area referred to above, the output may comprise (a) co-ordinates of each contact point (e.g. x, y co-ordinates, or button/contact pad identifier), and (b) the contact pressure exerted at each contact point (e.g. z). The contact pressure may be continuously updated while contact exists at that particular point. Alternatively, the touch pad or area may simply comprise an array of pressure sensors, each sensor continuously outputting a pressure value (which may be zero). Contact points can be determined by which sensors are outputting non-zero pressure values. The contact pressure may be expressed as an absolute value, or as a value on a normalised scale.

The relevant components of the computer system 300 are shown within dashed box 300. They include host CPU 301, RAM 302 and software interpreter 303. Software interpreter 303 may perform any necessary function, but in this preferred embodiment it is a guitar synthesiser which takes continuous and discrete control information, combined with machine learning for gesture recognition, and produces sound. Data transmitted from the first controller 100 is received via Bluetooth wireless receiver 304.

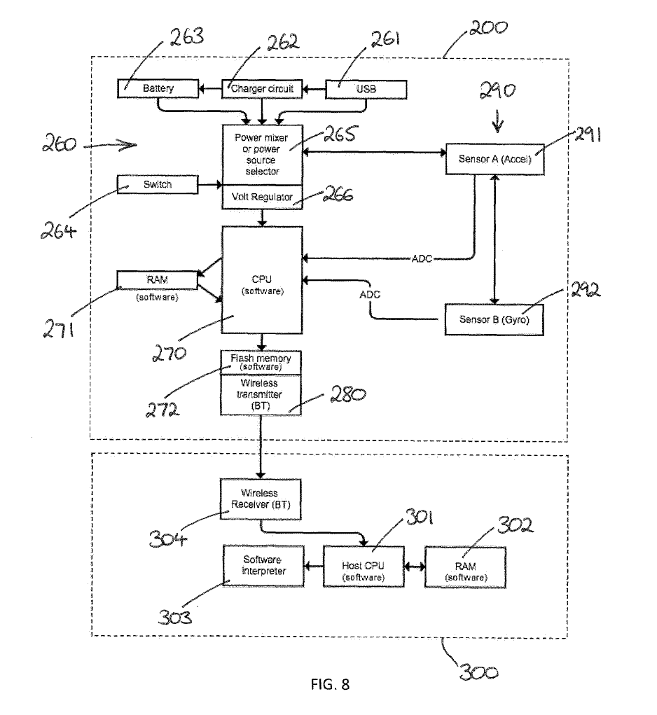

FIG. 8 shows a circuit block diagram of the control system of the present invention including the components of the second hand-held controller 200, which are shown within dashed box 200. The same relevant components of the computer system 300 are shown within dashed box 300 as in FIG. 7, including host CPU 301, RAM 302, software interpreter 303 and Bluetooth wireless receiver 304.

Second hand-held controller 200 will typically be used in combination with first hand-held controller 100, in which case Bluetooth wireless receiver 304 will receive data signals from both first and second controllers 100, 200. Separate data channels or groups of data channels may be provided for each controller.

Second controller 200 includes power supply circuitry shown generally as 260, including USB port 261, charging circuit 262, battery 263, switch 264, power mixer or power source selector 265 and voltage regulator 266. Other input/output ports may be provided in addition to USB port 261, including for example a data communications port for loading device firmware. Battery 263 is preferably rechargeable, ideally via the USB port, but it may be rechargeable by other means or may alternatively non-rechargeable. The power circuit 260 provides power to the rest of the components in a standard manner.

Second controller 200 also includes a CPU 270, which has access to RAM 271 and flash memory 272. Control data for the computer system 300 is output from CPU 270 to flash memory 272 and transmitted via Bluetooth wireless transmitter 280. CPU 270 needs to be capable of running the controller's software system at a high enough speed to allow for low latency continuous transmission. CPU 270 also has a permanent memory (not shown), which needs to be large enough to hold a suitable operating system and/or control software.

Transmitter 280 is capable of low-latency continuous transmission (<35 milliseconds transmission time per data block), such as a Bluetooth 4 BLE device, or any other type of communications device suitable for low-latency control. A cable can be used as an alternative.

The controller has an array of at least 16 analogue or digital channels suitable for multichannel input and output, for example 16 digital inputs/outputs, or 8 analogue inputs and 8 digital inputs/outputs to/from the CPU.

An array of sensors 290 is provided within second controller 200 in order that the user's overall movements of the controller can be converted into signals, processed as necessary by the CPU and transmitted to the computer system 300. Analogue to digital converters (ADCs) are employed to convert any analogue outputs from the sensors as needed. Sensor A (291) is an accelerometer, which is preferably a six-axis accelerometer. Sensor B (292) is a gyroscope.

Unlike first controller 100, second controller 200 does not include a pressure sensor. In addition, second controller 200 does not have a touch pad, touch area or keypad. Of course, it would be possible to provide second controller 200 with such additional user input devices, or to provide a second controller which is the same as or similar to first controller 100, in which case the block diagram would be very similar to FIG. 7 for the first controller 100. Any other applicable sensor which may be required for the specific application, including for example a magnetometer, may be included in second controller 200.

The software requirements of each hand-held controller and/or the system in general are as follows:
Computer firmware and operating system for accessing and controlling all hardware on the controller.
A low-latency input and output software package for receiving signals from the sensor array and sending them either through wires or wirelessly to a separate computer system.
A machine learning and signal processing layer for interpreting data from the sensor array either on the device itself, or on a separate computer system that is to be controlled. This allows the system to be used as a gesture recognizer for increasing the number of possible device interactions.
Driver software on the machine that is to be controlled.
Accompanying applications for the end user to use.

Each controller can also control any software system that relies on continuous signals (such as a mouse pointer, sliders or similar).

The first hand-held controller 100 can be used in a number of ways, discussed further below.

The touch pad 120 or touch area 120′ can be used to take the place of a traditional computer keyboard. In the case of the touch pad 120, the machine learning layer can make available a key ‘shift’ function, increasing the number of uses for the eight touch areas to any number of discrete keystrokes, of which eight can be used simultaneously. In addition, the pressure sensor array can provide both fine-grained control of discrete signals, and also be used in the same way as a traditional pointing device (such as a mouse). In this way, the device can be used to enter text on a computer or mobile device.

Also, the system can use sensor data including finger contact points and finger contact pressure on the touch pad or touch area to communicate the intensity and character of a person's grasp. This can be used to communicate emotion and expression, which can increase the happiness or sadness of emoticons automatically, for example.

The pressure and motion-based expression detection system can also be used to enhance the performance of predictive text software, providing deeper contextual information regarding a person.

The palm-based control system can be used as a controller in any and all situations where a traditional keyboard and/or mouse can be used, including any of the following contexts: controlling a computer game, controlling a game or movie via a virtual reality head-mounted device, controlling music software, controlling video editing software, controlling music editing software, editing photographs, Computer Aided Design software, designing websites, typing messages, letters, emails and documents, and using other forms of software.

The first hand-held controller can also be used as a remote control for any radio or network-controllable system including cars, drones, televisions, hi-fi systems, spacecraft, satellites, robotic systems and contact points such as NFC payment systems.

The first hand-held controller can also be used as a navigation tool in immersive virtual environments.

The first hand-held controller can work with other physical devices by tracking the user's hand motion and orientation, e.g. violin, golf club, tennis racket, cricket bat.

One preferred use of the control system of the present invention is in the specific context of music performance, composition, recording and production. With the first controller 100 being worn in the palm, and in combination with the plectrum-shaped second controller 200, the system of the present invention can be used by a person to select musical notes or musical chords, and to generate musical expression information such as vibrato, volume, tremolo, note-length, note frequency, note speed, note attach, note decay, note sustain and any other synthesizer parameter.

As will be discussed further below, a preferred use of the control system of the present invention is in the emulation of a guitar. The plectrum-shaped second controller 200 can also be used to simulate and control other aspects of a guitarist's sound, such as tremolo effects, string damping, and plectrum slides.

The control system can also be used to indicate changes in key, changes in register, how high or low the sound is, how much the sound should change, and what sound should be selected. This allows the system of the present invention to be used as a virtual guitar controller. It also allows it to be used to control software in a way that mimics the physical control method of other virtual stringed instruments such as those from the violin family, including violin, viola, cello, double bass, and any other stringed instrument that is struck, stroked, bowed, vibrated or caused to make sound with one hand whilst being controlled with another.

The present invention can also be used as a virtual percussion or virtual tuned percussion controller, allowing the wearer to play drum kits, timpani, tubular bells, xylophones, piano and other keyboard instruments.

The present invention can also be used as a virtual wind instrument controller through the addition of a microphone, onto which the user blows in a variety of ways to achieve the desired sound.

A more detailed description of a preferred embodiment of the control system of the present invention will now be given, when being used in guitar mode. Three components will be described: the palm-mounted keyboard (first controller 100), the plectrum (second controller 200), and the software.

The plectrum 200 consists of a custom made PCB and battery mounted inside a plastic housing. The battery is rechargeable via a micro-USB socket. There are two key components on the board: a motion sensor and a combined microcontroller and Bluetooth 4 transmitter. The motion sensor is connected to the microcontroller via an 12C serial interface. It has six axes of motion sensing: a 3-axis accelerometer and a 3-axis gyroscope. A program running on the microcontroller collects data from the motion sensor and transmits it via Bluetooth to a connected device at approximately 40 Hz, 16-bit resolution.

The palm-mounted keyboard 100 has exactly the same hardware as the plectrum, with the addition of a keyboard. The keyboard has eight pressure sensitive pads, connected to eight analogue inputs on the microcontroller. A program on the microcontroller repeatedly takes pressure readings from the eight pads by measuring the voltage at each analogue input. It transmits this data at 40 Hz, 16-bit resolution, along with the motion sensor data, to the connected computer system or mobile device. The pressure sensors are calibrated to respond to forces in the range of typical human touch.

The software runs on the computer system or mobile device with a Bluetooth 4 transceiver and an audio playback system. When the software is started, it searches the Bluetooth 4 network for the plectrum and keyboard, and connects to them. From now on, it receives continuous streams of data from these devices. In guitar mode, the plectrum is used to trigger discrete audio events, and the keyboard is used to determine how these events sound. Further to this, the motion sensor data from both devices is used to modify these sounds.

The player moves the plectrum to play notes in a similar manner to a normal guitar plectrum. To detect strumming or picking events from the plectrum, the software observes readings from the gyroscope, and processes the stream of data with an adaptive onset detector. When the onset detector detects a new event, the software will play a sound sample, the choice of which is determined by the state of the palm-mounted keyboard.

To determine which sound should be played, the software observes the eight pressure values being transmitted from the palm mounted keyboard device, using a set of onset detectors. If an onset detector triggers for a particular pressure sensitive pad, then the next sound played will be the sound mapped to this pad. The software offers a range of songs, each with a different set of samples mapped to each pad. These samples could be chords or single notes, with different pitches or tonal qualities.

Further to triggering sounds, the pressure data from the pads is also used to modify the tonal qualities of the sounds. For example, pressing the pad harder will make the sound louder. This modification may happen as a single event or continuously for the duration of the sound. For example, as a single event, the pressure reading at the beginning of playback of a sound will set a constant volume for playback of a sample over its entire duration. As a continuous controller, the pressure reading will, for example, allow the player to control a wah-wah effect while a sound is playing.

The motion data from either controller can be observed through a machine learning based gesture recognizer to trigger events. For example, if the player performs a fast back-and-forth rotation of their wrist on the hand where the keyboard is worn, the software will change to a different pre-determined set of sounds. If the player makes a motion with the plectrum emulating scraping a string on a guitar, then software will play a corresponding sound.

The software allows the player to either play freely, or to play to a guide track or backing track. In the latter case, the software can display animated notation instructing the player on what to play.

1. A hand-held controller for a computer, the controller having a front section and a rear section and being configured to fit onto the user's hand in use so that the rear section lies over the back of the hand and the front section lies in the palm of the hand, wherein the controller is adapted to receive a plurality of user inputs and wherein the front section includes a user interface to receive inputs from the user's fingers, the controller further comprising a transmitter for transmitting data relating to the user inputs to the computer.

2. The hand-held controller as claimed in claim 1, wherein the controller is substantially U-shaped and the front and rear sections are spaced apart by a link section.

3. The hand-held controller as claimed in claim 1, wherein the user inputs are converted into data signals by a plurality of sensors, the controller further comprising a processor which receives and processes the data signals for transmission to the computer.

4. The hand-held controller as claimed in claim 1, wherein the user interface is a keypad, touchpad or touch area.

5. The hand-held controller as claimed in claim 1, wherein the user interface senses the presence of a user's finger.

6. The hand-held controller as claimed in claim 1, wherein the user interface senses the location of a user's finger.

7. The hand-held controller as claimed in claim 1, wherein the user interface senses the pressure applied by a user's finger.

8. The hand-held controller as claimed in claim 1, wherein the user interface comprises a touch pad or touch area comprising an array of pressure sensors.

9. The hand-held controller as claimed in claim 1, wherein the controller is adapted to receive further user inputs relating to the orientation or movement of the controller.

10. The hand-held controller as claimed in claim 9, wherein the controller includes a gyroscope and an accelerometer to determine the orientation and movement of the controller.

11. The hand-held controller as claimed in claim 1, wherein the data transmitted to the computer system causes the computer system to carry out one or more pre-assigned actions.

12. The hand-held controller as claimed in claim 1, wherein the front and rear sections are configured so as to maintain the controller in position on the user's hand without the need for the user to hold or otherwise grip the controller.

13. The hand-held controller as claimed in claim 12, wherein the front and rear sections are closer together at the open end of the U-shape in order to hold the controller in position on the user's hand.

14. The hand-held controller as claimed in claim 13, wherein the front and rear sections can be urged apart from their rest positions against a resilient biasing force.

15. A control system for a computer, the control system comprising a first hand-held controller being the hand-held controller of claim 1 and a second hand-held controller, wherein the second controller is adapted to receive user inputs relating to the orientation or movement of the second controller and further comprises a transmitter for transmitting data relating to the user inputs to the computer.

16. The control system as claimed in claim 15, wherein the second controller includes an accelerometer and a gyroscope to determine the orientation and movement of the second controller.

17. The control system as claimed in claim 15 or 16, wherein the second controller has a front section and a rear section and is configured to fit onto a user's hand in use so that the rear section lies over the back of the hand and the front section lies in the palm of the hand, wherein the controller is adapted to receive a plurality of user inputs and wherein the front section includes a user interface to receive inputs from the user's fingers, the controller further comprising a transmitter for transmitting data relating to the user inputs to the computer.

18. A computer system comprising a first hand-held controller being the hand-held controller of claim 1, a second hand-held controller and a computer, wherein the second controller is adapted to receive user inputs relating to the orientation or movement of the second controller and comprises a transmitter for transmitting data relating to the user inputs to the computer, wherein the computer receives the transmitted data relating to the user inputs from the first and second controllers and carries out pre-assigned actions in dependence on that data.

19. The computer system as claimed in claim 18, wherein the computer system is a musical instrument emulator.

20. The computer system as claimed in claim 18, wherein the data transmitted to the computer system causes the computer system to carry out one or more pre-assigned actions.

21. The computer system as claimed in claim 18, wherein the computer recognises or learns gestures made by the user which are sensed by the first and/or second hand-controller, and wherein the computer carries out a pre-assigned action for each recognised gesture.

22. The computer system as claimed in claim 20, wherein the pre-assigned action comprises playing or altering an audio sound.

23. The computer system as claimed in claim 22, wherein the pre-assigned action comprises changing the key, pitch, tone, sound quality or volume of the audio sound.
